(19) United States
(12) Patent Application Publication
(10) Pub. No.: US 2017/0055529 A1
(43) Pub. Date: Mar. 2, 2017

(54) BROAD SPECTRUM WEED CONTROL IN FLOODED RICE BY IN-WATER APPLICATION OF AUXIN HERBICIDES

(71) Applicant: Dow AgroSciences LLC, Indianapolis, IN (US)

(72) Inventors: Richard K. Mann, Indianapolis, IN (US); Ändrea Christine McVeigh-Nelson, Indianapolis, IN (US); Carla N. Yerkes, Crawfordsville, IN (US); Yi-hsiou Huang, Pingtung Country (TW)

(73) Assignee: Dow AgroSciences LLC, Indianapolis, IN (US)

(21) Appl. No.: 15/243,040

(22) Filed: Aug. 22, 2016

Related U.S. Application Data
(60) Provisional application No. 62/210,093, filed on Aug. 26, 2015.

(51) Int. Cl. A01N 43/40; A01N 37/38

(52) U.S. Cl. CPC A01N 43/40; A01N 37/38

(57) ABSTRACT

Commercially important weeds in flooded rice are controlled by in-water application of the auxin herbicides 2,4-D, triclopyr, fluroxypyr, and clopyralid. At application rates of about 35 to about 1120 grams acid equivalent per hectare (g ae/ha), 2,4-D, triclopyr, fluroxypyr, and clopyralid are highly efficacious on several commercially relevant grass, broadleaf and sedge weeds and cause little to no rice crop injury.

### CROSS REFERENCE TO RELATED APPLICATIONS

This application claims the benefit of U.S. Provisional Patent Application Ser. No. 62/210,093 filed Aug. 26, 2015, which is expressly incorporated by reference herein.

### BACKGROUND

Rice farmers are constantly battling weeds in an effort to improve crop yields. Auxin herbicides are typically applied as post-emergence foliar applications for control of broadleaf weeds and some sedge species in rice. Application rates vary from about 280 to about 1120 grams acid equivalent per hectare (g ae/ha).

### SUMMARY

Methods for the selective control of undesirable broadleaf weeds, sedges and barnyardgrass in flooded dry-seeded, water-seeded or transplanted rice include applying a herbicidally effective amount of 2,4-D, triclopyr, fluroxypyr, or clopyralid, or an agriculturally acceptable ester or salt thereof, to the flooded rice as an in-water treatment, water injected treatment, or application to a surface of rice paddy water resulting in dispersion of the herbicidally active ingredient throughout the water profile.

### DETAILED DESCRIPTION

The methods described herein can be used to control weeds in flooded rice. Specifically, provided herein are methods for the selective post-emergence control of undesirable broadleaf weeds, sedges and barnyardgrass in flooded rice that include applying a herbicidally effective amount of 2,4-D, triclopyr, fluroxypyr, or clopyralid, or an agriculturally acceptable ester or salt thereof, to the flooded rice, by applying the herbicidally effective amount of the active ingredients as an in-water treatment, water injected treatment, or application to a surface of rice paddy water resulting in dispersion of the herbicidally active ingredient throughout the water profile. In these methods, the compounds can be applied by water injection or in-water application such as by applying the active ingredient in a diluted aqueous solution, an undiluted liquid formulation or as a granule, as an application directly into the rice paddy water or onto the rice paddy water, such that the active ingredient becomes dispersed in the total water volume of the flooded rice paddy and comes into contact with the submerged leaves, stems or roots of the weeds and crop. Application can be accomplished with dry granules, shaker bottle, direct stream spray, backpack spray, aerial spray or any means thereof that deliver the active ingredient to the surface of the flooded rice paddy or directly into the water body of the rice paddy which results in physical or chemical dispersion throughout the water profile after application.

### DEFINITIONS

As used herein, 2,4-D is (2,4-dichlorophenoxy)acetic acid and has the following structure:

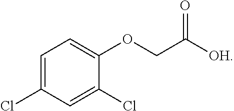 [SMILES: O=C(O)COc1ccc(Cl)cc1Cl]

Exemplary uses of 2,4-D are described in Tomlin, C. D. S., Ed. The Pesticide Manual: A World Compendium, 15^{th} ed.; BCPC: Alton, 2009 (hereafter “The Pesticide Manual, Fifteenth Edition, 2009”) and include, but are not limited to, post-emergence control of annual and perennial broadleaf weeds, e.g., in cereals, maize, sorghum, grassland, established turf, grass seed crops, orchards, cranberries, asparagus, sugarcane, rice, forestry and non-crop land. Chemical forms of 2,4-D include, but are not limited to, salt or ester forms, for example, 2,4-D DMA, which is dimethylammonium 2-(2,4-dichlorophenoxy)acetate and has the following structure:

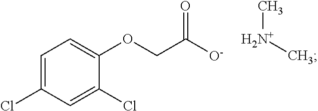

or
2,4-D Ester, which is 2-ethylhexyl 2,4-dichlorophenoxy)acetate and has the following structure:

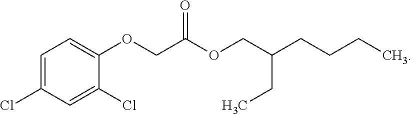 [SMILES: CCCCC(CC)COC(=O)COc1ccc(Cl)cc1Cl]

2,4-D Choline, which is the choline salt of 2,4-dichlorophenoxyacetic acid or 2-hydroxy-N,N,N-trimethylethanaminium 2-(2,4-dichlorophenoxy)acetate, has the following structure:

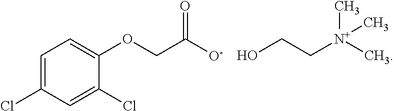

As used herein, fluroxypyr is 2-[(4-amino-3,5-dichloro-6-fluoro-2-pyridinyl)oxy]-acetic acid and has the following structure:

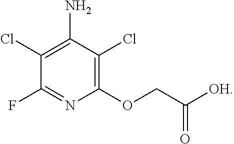 [SMILES: Nc1c(Cl)c(F)nc(OCC(=O)O)c1Cl]

Exemplary uses of fluroxypyr are described in The Pesticide Manual, Fifteenth Edition, 2009 and include post-emergence foliar application to control broadleaf weeds, e.g., in small grain crops, to control Rumex spp. and Urtica dioica in pastures, and to control Trifolium repens in amenity grassland. Other exemplary uses include control of herbaceous and woody broadleaf weeds, e.g., in orchards and plantation crops, and broadleaf brush, e.g., in conifer forests. Chemical forms of fluroxypyr include, but are not limited to, fluroxypyr-meptyl or fluroxypyr MHE, which is 1-methylheptyl 2-[(4-amino-3,5-dichloro-6-fluoro-2-pyridinyl)oxy]acetate and possesses the following structure:

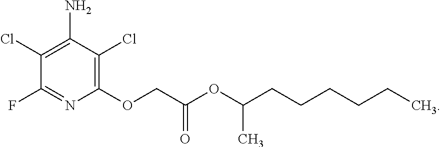 [SMILES: CCCCCCC(C)OC(=O)COc1nc(F)c(Cl)c(N)c1Cl]

As used herein, triclopyr is 2-[(3,5,6-trichloro-2-pyridinyl)oxy]acetic acid and has the following structure:

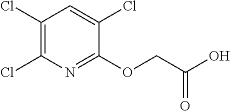 [SMILES: O=C(O)COc1nc(Cl)c(Cl)cc1Cl]

Exemplary uses of triclopyr are described in The Pesticide Manual, Fifteenth Edition, 2009 and include, but are not limited to, control of woody plants and broadleaf weed species, e.g., in grassland, uncultivated land, industrial areas, coniferous forests, rice and plantation crops. Chemical forms of triclopyr include but are not limited to, for example, triclopyr TEA, which is triethylammonium 2[(3,5,6-trichloro-2-pyridinyl)oxy]acetate and has the following structure:

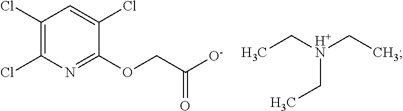

triclopyr choline, which is 2-hydroxy-N,N,N-trimethylethanaminium 2-[(3,5,6-trichloro-2-pyridinyl)oxy]acetate and has the following structure:

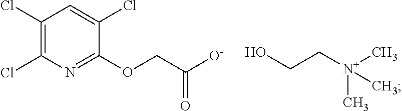

and
triclopyr BEE, which is 2-butoxyethyl 2[(3,5,6-trichloro-2-pyridinyl)oxy]acetate and has the following structure:

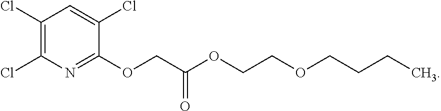 [SMILES: CCCCOCCOC(=O)COc1nc(Cl)c(Cl)cc1Cl]

As used herein, clopyralid is 3,6-dichloro-2-pyridinecarboxylic acid, which has the following structure:

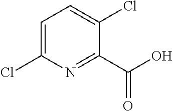 [SMILES: O=C(O)c1nc(Cl)ccc1Cl]

Exemplary uses of clopyralid are described in The Pesticide Manual, Fifteenth Edition, 2009 and include, but are not limited to, post-emergence control of many annual and perennial broadleaf weeds, e.g., in sugar beet, fodder beet, oilseed rape, maize, cereals, brassicas, onions, leeks, strawberries and flax, and in grassland and non-crop land. Chemical forms of clopyralid include, but are not limited to, for example, clopyralid MEA or clopyralid olamine, which is 2-hydroxyethanaminium 3,6-dichloro-2-pyridinecarboxylate and has the following structure:

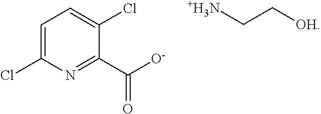

As used herein, herbicide means an active ingredient that kills, controls or otherwise adversely modifies the growth of plants. And a herbicidally effective or vegetation controlling amount is an amount of active ingredient that causes a “herbicidal effect”, i.e. an adversely modifying effect, and includes deviations from natural development, killing, regulation, desiccation and retardation.

As used herein, selective post-emergence control of undesirable vegetation means preventing, reducing, killing, or otherwise adversely modifying the development of the undesirable vegetation in the presence of crop plants with limited adverse effect on the crop plants. For example, broadleaf weed control of 80% (rated visually) with crop injury of less than or equal to 20%, rated visually, would constitute selective control. In some embodiments the adverse effect on crop plants is limited to less than 10% or 15% visually rated crop injury. Visual crop injury is a composite rating accounting for all phytotoxic effects including necrosis, chlorosis, growth inhibition, epinasty, delays in maturity, stand reduction and seed head deformity. Visual weed control is a composite rating accounting for reductions in plant biomass, necrosis, chlorosis and growth inhibition.

As used herein, water injection or in-water application of a herbicide or herbicidal composition means delivering it by application directly into the water or directly onto the water surface whereby it becomes diluted in the rice paddy water, resulting in the herbicide being absorbed by the submerged targeted vegetation leaves, stems and/or roots, or to the locus thereof or to the area where control of undesired vegetation is desired, but not spraying directly on the rice plants and/or surrounding vegetation foliage.

As used herein, the terms “plants” and “vegetation” include, but are not limited to, germinant seeds, emerging seedlings, plants emerging from vegetative propagules, and established vegetation.

As used herein, immature vegetation refers to small vegetative plants prior to reproductive stage, and mature vegetation refers to vegetative plants during and after the reproductive stage.

As used herein, agriculturally acceptable salts and esters of a herbicide refer to salts and esters that (a) do not substantially affect the herbicidal activity and (b) are or can be hydrolyzed, oxidized, metabolized, or otherwise converted in plants or soil to the corresponding carboxylic acid which, depending on the pH, may be in the dissociated or undissociated form. Exemplary salts include those derived from alkali or alkaline earth metals and those derived from ammonia and amines Exemplary cations include sodium, potassium, magnesium, and ammonium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide.

Exemplary esters include those derived from C₁-C₁₂, alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

### Methods of Use

Herbicidal activity is exhibited by the compounds described herein when they are applied into or onto the paddy water to the submerged locus of the plant to be controlled at any stage of growth. The effect observed depends upon the plant species to be controlled, the stage of growth of the plant, the degree that the plants to be controlled are submerged, the water quality, the water depth, the application parameters of dilution, the environmental conditions at the time of use, the specific compound employed, the specific adjuvants and carriers employed, and the like, as well as the amount of chemical applied. These and other factors can be adjusted to promote non-selective or selective herbicidal action. In the present methods, the compositions described herein are applied as a water-injected treatment directly into or onto the paddy water to be diluted and dispersed throughout the paddy water and absorbed by the submerged leaves, stems and roots of relatively immature undesirable vegetation to achieve the maximum control.

The present compositions can be applied to weeds or their locus by the use of dry granules, shaker bottle, direct stream spray, backpack spray, aerial spray or any means thereof that deliver the active ingredient to the surface of the flooded rice paddy or directly into the water body of the rice paddy by physical or chemical dispersion after application, by addition to irrigation water, and by other conventional means known to those skilled in the art.

The concentration of the active ingredients in the compositions described herein can be from 0.0005 to 98 percent by weight, or from 0.0006 to 90 percent by weight. In compositions designed to be employed as concentrates, the active ingredients can be present in a concentration from 0.1 to 98 weight percent or 0.5 to 90 weight percent. Such compositions are, in certain embodiments, diluted with an inert carrier, such as water, before application. The diluted compositions usually applied to weeds or the locus of weeds contain 0.0006 to 3.0 weight percent active ingredient or contain 0.01 to 0.3 weight percent active ingredient.

Examples of undesirable vegetation found in rice controllable by the methods described herein include, but are not limited to, Urochloa platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colona (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (fall panicum, PANDI), Paspalum dilatatum Poir. (dallisgrass, PASDI), Cyperus difformis L. (small-flower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SCPJU), Schoenoplectus maritimus L. (sea clubrush, SCPMA), Schoenoplectus mucronatus L. (ricefield bulrush, SCPMU), Aeschynomene species (jointvetch, AESSS), Alternanthera philoxeroides (Mart.) Griseb. (alligatorweed, ALRPH), Alisma plantago-aquatica L. (common waterplantain, ALSPA), Amaranthus species (pigweeds and amaranths, AMASS), Ammannia coccinea Rottb. (redstem, AMMCO), Eclipta alba (L.) Hassk. or Eclipta prostrata (L.) L. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindemia dubia (L.) Pennell (low false pimpernel, LIDDU), Ludwigia hyssopyfolia (G. Don) Exell or Ludwigia linifolia Poir. (linear leaf water primrose, LUDLI), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L. (Pennsylvania smartweed, POLPY), Polygonum persicaria L. (ladysthumb, POLPE), Polygonum hydropiperoides Michx. (mild smartweed, POLHP), Rotala indica (Willd.) Koehne (Indian toothcup, ROTIN), Sagittaria species (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

Application rates useful with the methods described herein can be from 17 to 1120 grams acid equivalent per hectare (g ae/ha). Further examples of useful application rates include, but are not limited to, 35 to 1120 g ae/ha, 70 to 1120 g ae/ha, 140 to 1120 g ae/ha, 17 to 560 g ae/ha, 35 to 560 g ae/ha, 70 to 560 g ae/ha, 140 to 560 g ae/ha, 17 to 280 g ae/ha, 35 to 280 g ae/ha, 70 to 280 g ae/ha, 140 to 280 g ae/ha, 17 to 140 g ae/ha, 35 to 140 g ae/ha, 70 to 140 g ae/ha, 17 to 70 g ae/ha, 35 to 70 g ae/ha, and 17 to 35 g ae/ha. Additional examples of useful application rates include, but are not limited to, less than or equal to 1120 g ae/ha, less than or equal to 560 g ae/ha, less than or equal to 280 g ae/ha, less than or equal to 140 g ae/ha, less than or equal to 70 g ae/ha, and less than or equal to 35 g ae/ha.

At an application rate of about 35 to about 280 g ae/ha, which is much lower than that of a typical post-emergence foliar application, 2,4-D, triclopyr, fluroxypyr and clopyralid are highly efficacious on several commercially relevant weeds, including barnyardgrass (Echinochloa crus-galli), small-flower flatsedge (Cyperus difformis), Japanese bulrush (Schoenoplectus juncoides) and monochoria (Monochoria vaginalis). The level of crop safety exhibited by rice toward 2,4-D, triclopyr, fluroxypyr or clopyralid is variable, but generally application rates of less than or equal to 280 g ae/ha cause little to no crop injury.

Examples of resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinylthiobenzoates, dimethoxy-pyrimidines, triazolopyrimidine sulfonamides, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidinediones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes of action such as quinclorac, and unclassified herbicides such as arylaminopropionic acids, difenzoquat, endothall, and organoarsenicals. Additional resistant or tolerant weeds include, but are not limited to, biotypes with resistance or tolerance to single or multiple herbicides, biotypes with resistance or tolerance to single or multiple chemical classes, biotypes with resistance or tolerance to single or multiple herbicide modes of action, and biotypes with single or multiple resistance or tolerance mechanisms (e.g., target site resistance or metabolic resistance).

The methods described herein can also be used in rice that is modified, i.e., either genetically or through breeding, to be resistant to certain herbicides, e.g., dicamba, 2,4-D, glyphosate, or glufosinate. Such rice that is glyphosate-, 2,4-D- or glufosinate-tolerant may also include traits providing dicamba-tolerance (e.g., DMO), pyridyloxy auxin-tolerance (e.g., aad-12, aad-13), auxin-tolerance, auxin transport inhibitor-tolerance, acetyl CoA carboxylase (ACCase) inhibitor-herbicide tolerance [e.g., aryloxyphenoxypropionate, cyclohexanedione, and phenylpyrazoline chemistries (e.g., various ACCase genes and aad-1 gene)], acetolactate synthase (ALS)-inhibiting herbicide tolerance (e.g., imidazolinone, sulfonylurea, triazolopyrimidine sulfonamide, pyrimidinylthiobenzoate, and other chemistries=AHAS, Csrl, SurA), 4-hydroxyphenyl-pyruvate dioxygenase (HPPD) inhibitor-tolerance, phytoene desaturase (PDS) inhibitor-tolerance (e.g., pds, CYP1A1, CYP2B6, CYP2C19), carotenoid biosynthesis inhibitor-tolerance, protoporphyrinogen oxidase (PPO) inhibitor-tolerance, cellulose biosynthesis inhibitor-tolerance (e.g., ixr2-1, CYP1A1), mitosis inhibitor-tolerance, microtubule inhibitor-tolerance, very long chain fatty acid (VLCFA) inhibitor-tolerance (e.g., CYP1A1, CYP2B6, CYP2C19), fatty acid and lipid biosynthesis inhibitor-tolerance (e.g., CYP1A1), photosystem I inhibitor-tolerance (e.g., SOD), photosystem II inhibitor (triazine, nitrile, and phenylurea chemistries) tolerance (e.g., psbA, CYP1A1, CYP2B6, CYP2C19, and Bxn), in rice, for example, in conjunction with glyphosate, 5-enolpyruvylshikimate-3-phosphate (EPSP) synthase inhibitors, glutamine synthase inhibitors, dicamba, phenoxy auxins, pyridyloxy auxins, synthetic auxins, auxin transport inhibitors, aryloxyphenoxypropionates, cyclohexanediones, phenylpyrazolines, ACCase inhibitors, imidazolinones, sulfonylureas, pyrimidinylthiobenzoates, dimethoxy-pyrimidines, triazolopyrimidine sulfonamides, sulfonylaminocarbonyltriazolinones, ALS or acetohydroxy acid synthase (AHAS) inhibitors, HPPD inhibitors, PDS inhibitors, carotenoid biosynthesis inhibitors, PPO inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil. The compositions and methods may be used in controlling undesirable vegetation in rice possessing single and multiple or stacked traits conferring tolerance to single or multiple chemistries and/or inhibitors of multiple modes of action.

In the methods described herein, the compounds exhibit activity against a variety of weed types. For example, 2,4-D, triclopyr, fluroxypyr, or clopyralid or an agriculturally acceptable ester or salt thereof, exhibit greater than about 5, 6, 7, 8, 9, 10, 11, 13, 15, 18, 20, 21, 22, 23, 24, 25, 30, 35, 40, 45, 50, 55, 60, 65, 70, 75, 80, 85, 90, or 95% control compared to the untreated control value at 16-31 days after application (DAA).

In the methods described herein, the compounds exhibit activity as defined by the efficacy values defined above against a variety of weed types or crops, including but not limited to, barnyardgrass (Echinochloa crus-galli), small-flower flatsedge (Cyperus difformis), Japanese bulrush (Schoenoplectus juncoides) and monochoria (Monochoria vaginalis).

Combination with Other Actives

The mixtures described herein can be applied in conjunction with one or more other herbicides to control a wider variety of undesirable vegetation. When used in conjunction with other herbicides, the composition can be formulated with the other herbicide or herbicides, tank-mixed with the other herbicide or herbicides, or applied sequentially with the other herbicide or herbicides. Examples of herbicides that can be employed in conjunction with the compositions and methods described herein include, but are not limited to, 4-CPA, 4-CPB, 4-CPP, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, aminotriazole, amitrole, ammonium sulfamate, ammonium thiocyanate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, bentazon-sodium, benthiocarb, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlormequat, chlornitrofen, chloropon, chlorotoluron, chloroxuron, chloroxynil, chlorpropham, chlorsulfuron, chlorthal, chlorthiamid, chlorotoluron, cinidon-ethyl, cinmethylin, cinosulfuron, cisanilide, clacyfos, clethodim, cliodinate, clodinafop-propargyl, clofop, clomazone, clomeprop, cloprop, cloproxydim, cloransulam-methyl, CMA, copper sulfate, CPMF, CPPC, credazine, cresol, cumyluron, cyanatryn, cyanazine, cycloate, cyclopyralid, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florasulam, florpyrauxifen, florpyrauxifen-benzyl, fluazifop, fluazifop-P-butyl, fluazolate, flucarbazone, flucetosulfuron, fluchloralin, flufenacet, flufenican, flufenpyr-ethyl, flumetsulam, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, fumiclorac, furyloxyfen, gibberellic acid, glufosinate, glufosinate-ammonium, glufosinate-P-ammonium, glyphosate, halauxifen, halauxifen-methyl, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lancotrione, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, 1-methylcyclopropene, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, 1-naphthaleneacetic acid, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, pyroxsulam, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron, tribenuron-methyl, tricamba, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor and salts, esters, optically active isomers and mixtures thereof.

The compositions and methods described herein can, further, be used in conjunction with one or more of the listed additional herbicides on herbicide-tolerant rice. The compounds and methods described herein can be used in combination with herbicides that are selective for use in rice to complement the spectrum of weeds controlled at the application rates employed.

### Safeners

The compositions described herein can be employed in combination with one or more herbicide safeners including but not limited to, AD-67 (MON 4660), benoxacor, benthiocarb, brassinolide, cloquintocet (e.g., cloquintocet (mexyl)), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148 and N-phenyl-sulfonylbenzoic acid amides, 1-[4-(N-(2-methoxybenzoyl)sulfamoyl)phenyl]-3-methylurea, N-(2-methoxybenzoyl)-4-[(methylaminocarbonyl)amino]benzenesulfonamide, to enhance their selectivity. The safener cloquintocet or an ester or salt thereof, e.g., cloquintocet (mexyl), is commonly used. In some cases, cloquintocet can be used to antagonize harmful effects of the compositions on rice.

### Adjuvants/Carriers

The compositions described herein can further include at least one agriculturally acceptable adjuvant or carrier. The adjuvant or carrier can be a liquid or a solid. Suitable adjuvants or carriers should not be phytotoxic to rice, particularly at the concentrations employed in applying the compositions for selective weed control in the presence of rice, and should not react chemically with herbicidal components or other composition ingredients. The adjuvants/carriers can be combined with the one or more herbicides to prepare compositions and formulations for application directly into the water to the weeds or their locus or can be concentrates or formulations that are normally diluted with additional carriers and adjuvants before application. The compositions/formulations (including adjuvants/carriers) can be solids, such as, for example, dusts, granules, water-dispersible granules, or wettable powders, or liquids, such as, for example, emulsifiable concentrates, solutions, emulsions, self-emulsifying formulations or suspensions or dispersions. They can also be provided as a pre-mix or tank-mixed, or applied sequentially.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99; paraffinic oil, alkoxylated alcohol non-ionic surfactant; mineral oil surfactant blend.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono-, di- and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. For example, water can be the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

The compositions described herein can further include one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corporation: Ridgewood, N.J., 1998, and in Encyclopedia of Surfactants, Vol. I-III, Chemical Publishing Company: New York, 1980-81. Surface-active agents include, but are not limited to, salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, for example, methyl esters.

These materials, such as vegetable or seed oils and their esters, can be used interchangeably as an agricultural adjuvant, as a liquid carrier, as a dispersing agent or as a surface active agent.

Other exemplary additives for use in the compositions provided herein include but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### Examples

### Greenhouse Evaluation of In-Water Applied Herbicidal Activity in Transplanted Paddy Rice (Small Pots)

Weed seeds of the desired test plant species were planted in puddled soil (mud) prepared by mixing a non-sterilized mineral soil (approximately 50 percent silt, 26 percent clay, and 24 percent sand, with a pH of about 7.6 and an organic matter content of about 2.9 percent) and water at a 1:1 volumetric ratio. The prepared mud was dispensed in 365 milliliter (mL) aliquots into 16-ounce (oz.) non-perforated plastic pots with a surface area of 86.59 square centimeters (cm²) leaving a headspace of 3 centimeters (cm) in each pot. Mud was allowed to dry overnight prior to planting or transplanting. Rice seeds were planted in Sun Gro® MetroMix® 360 planting mixture, which typically has a pH of 6.0 to 6.8 and an organic matter content of about 30 percent, in plastic plug trays. Seedlings at the second or third leaf stage of growth were transplanted into 840 mL of mud contained in 32-oz. non-perforated plastic pots with a surface area of 86.59 cm² four days prior to herbicide application. The paddy was created by filling the headspace of the pots with 2.5 to 3 cm of water. When required to ensure good germination and healthy plants, a fungicide treatment and/or other chemical or physical treatment was applied. The plants were grown for 4-22 days (d) in a greenhouse with an approximate 14-hour (h) photoperiod which was maintained at about 29° C. during the day and 26° C. during the night. Nutrients were added as Osmocote® (19:6:12, Nitrogen:Phosphorus:Potassium (N:P:K)+minor nutrients) at 2 g per 16 oz. pot and 4 g per 32 oz. pot. Water was added on a regular basis to maintain the paddy flood, and supplemental lighting was provided with overhead metal halide 1000-Watt lamps as necessary. The plants were used for testing when they reached the second or third true leaf stage.

Triclopyr triethylammonium (as Grandstand® R, 359.5 grams acid equivalent per liter (g ae/L)); fluroxypyr methylheptyl ester (meptyl or MHE, as Starane™, 179.8 g ae/L); 2,4-dichlorophenoxyacetic acid dimethylammonium (2,4-D DMA, as Weedar® 64, 455.4 g ae/L); and penoxsulam (as Grasp® SC, 239.7 grams active ingredient per liter (g ai/L) were used. Measured amounts of formulated compounds were placed in individual 120 mL glass vials and were dissolved in 40 mL of an aqueous mixture containing 1.25% volume per volume (v/v) Agri-Dex® crop oil concentrate. Generally, multiple concentrations were tested utilizing the same stock solution. Applications were made by injecting an appropriate amount of the application solution into the aqueous layer of the paddy. Control plants were treated in the same manner with the solvent blank.

The treated plants and control plants were placed in a greenhouse as described above and water was added as needed to maintain a paddy flood. After approximately 3 weeks the condition of the test plants, compared with that of the untreated plants, was determined visually and scored on a scale of 0 to 100 percent where 0 corresponds to no injury or growth reduction and 100 corresponds to complete kill.

Some of the compounds tested, application rates employed, plant species tested, and results are given in Table 1.

TABLE 1
Activity of In-Water Herbicidal Compounds in Flooded Rice Cropping
Systems (20 Days after Application (DAA)) in the Greenhouse

| | | Percent (%) Visual Injury Ratings - 20 DAA | | | | | |
|---|---|---|---|---|---|---|---|
| | Rate | M202′ | Wells′ | | | | |
| Compound | (g ae/ha) | Rice | Rice | ECHCG | CYDPI | SCPJU | MOOVA |
| Triclopyr | 1120 | 20 | 10 | 85 | 100 | 100 | 100 |
| (Grandstand ® R) | 560 | 0 | 0 | 70 | 100 | 95 | 99 |
| | 280 | 0 | 0 | 40 | 100 | 70 | 95 |
| Fluroxypyr- | 1120 | 35 | 10 | 99 | 100 | 100 | 100 |
| meptyl (MHE) | 560 | 0 | 0 | 25 | 100 | 90 | 100 |
| (Starane ™) | 280 | 0 | 0 | 0 | 100 | 60 | 85 |
| 2,4-D DMA | 1120 | 10* | 0 | 80 | 100 | 100 | 99 |
| (Weedar ® 64) | 560 | 0 | 0 | 20 | 100 | 100 | 100 |
| | 280 | 0 | 0 | 0 | 90 | 70 | 90 |
| Penoxsulam | 35 | 10 | 10* | 99 | 100 | 100 | 99 |
| (Grasp ® SC) | | | | | | | |

*Root injury;
ECHCG = Echinochloa crus-galli (barnyardgrass);
CYDPI = Cyperus difformis (small-flower flatsedge);
SCPJU = Schoenoplectus juncoides (Japanese bulrush);
MOOVA = Monochoria vaginalis (monochoria);
‘M202’ = Japonica rice variety from California, USA;
‘Wells’ = Medium grain rice variety from Arkansas, USA

### Greenhouse Evaluation of In-Water Applied Herbicidal Activity in Transplanted Paddy Rice (Large Pots)

Weed seeds or nutlets of the desired test plant species were planted in puddled soil (mud) prepared by mixing shredded topsoil and deionized (DI) water in a 1:1 ratio in a standard cement mixer. The mud moisture content may be checked in the following manner (U sing a 15-cm diameter circular piece of a flat, non-absorbent hard plastic material as a guide, 380 mL of mud is placed in the center of the plastic circle. Mud with the desired moisture content should spread perfectly to inscribe the circle. If the mud spreads beyond the circle's perimeter, it is too moist, and more topsoil must be added to the mud. If the mud does not spread to inscribe fully the circle, it is too dry and more DI water must be added to the mud.) The topsoil to water ratio should be adjusted until the correct moisture content is achieved as described. Osmocote® (17:6:10 N:P:K; 0.5 teaspoon) was added to the bottom of a container. The container is a high-density polyethylene (HDPE) round container (4.163 L (1.1 gallon), 15 cm high×20.55 cm diameter; for treatment purposes, the surface area is calculated as 331 cm² with 1 hectare equivalent to 10⁸ cm²). The mud mixture (2,750 mL) was added to the container filling it half full. Stakes were placed horizontally in each container to create separate areas for which to plant each different plant species. Water was added on a regular basis to maintain the paddy flood, and supplemental lighting was provided with overhead metal halide 1000-Watt lamps as necessary.

Once the plants had reached the proper size (the growth stage of the various species ranged from 2 to 4 leaves), the containers were flooded with city water to a depth of 3 cm submerging the plants 80-100%. The outside of each container was measured and marked at a 3-cm line with a black permanent marker to eliminate water level variability during the trial period. Water was added daily to maintain this water depth. Triclopyr triethylammonium (as Garlon® 3 A, 360 g ae/L); triclopyr butoxyethyl ester (as Garlon® 4, 480 g ae/L); fluroxypyr methylheptyl ester (meptyl or MHE, as Starane® Ultra, 333 g ae/L); fluroxypyr acid (850 grams acid equivalent per kilogram (g ae/kg)); 2,4-dichlorophenoxyacetic acid dimethylammonium (2,4-D DMA, as Weedar® 64 EC, 456 g ae/L); 2,4-dichlorophenoxyacetic acid 2-ethylhexyl ester (2,4-D 2-EHE, as Agri Star®, 456 g ae/L); clopyralid olamine (as Stinger®, 360 g ae/L); and penoxsulam (as Grasp® SC, 240 g ai/L) were used. Each herbicide treatment for each pot was mixed in water (80 mL) and applied directly into the paddy water at rates adjusted to the surface area. The dry formulations were pre-weighed based on the rate of the active ingredient to be applied on a per unit area basis, placed in 30 mL vials, and capped. Granules were spread onto the top of the water in each pot and dispersed throughout the water. Treatments were replicated 3 times.

The treated plants and control plants were placed in a greenhouse as described above and water was added as needed to maintain a flood depth of 3 cm. After 3 weeks the test plants were compared to untreated plants and scored on a scale of 0 to 100 percent where 0 corresponds to no injury and 100 corresponds to complete kill.

Some of the compounds tested, application rates employed, plant species tested, and results are given in Tables 2, 3 and 4.

TABLE 2
Activity of In-Water Herbicidal Compounds in Rice Cropping
Systems (31 Days after Application (DAA)) in the Greenhouse

| | Rate | Percent (%) Visual Injury Ratings - 31 DAA | | | | | | | |
|---|---|---|---|---|---|---|---|---|---|
| Compound | (g ae/ha) | ECHCG | | CYPDI | | MOOVA | | ORYSP | |
| Triclopyr | 280 | 65 | ef | 97 | a | 100 | a | 1 | h |
| triethanolamine | 560 | 75 | de | 99 | a | 100 | a | 5 | g |
| (Garlon ® 3A) | 1120 | 89 | ab | 100 | a | 100 | a | 70 | c |
| Triclopyr butoxyethyl | 280 | 60 | f | 100 | a | 100 | a | 3 | gh |
| ester (Garlon ® 4) | 560 | 78 | cd | 100 | a | 100 | a | 22 | e |
| | 1120 | 95 | ab | 100 | a | 100 | a | 72 | bc |
| Fluroxypyr-meptyl | 280 | 45 | g | 100 | a | 100 | a | 5 | g |
| (Starane ® Ultra) | 560 | 75 | de | 100 | a | 100 | a | 28 | d |
| | 1120 | 99 | a | 100 | a | 100 | a | 73 | b |
| Fluroxypyr acid | 280 | 27 | h | 100 | a | 98 | a | 0 | h |
| | 560 | 28 | h | | | | | 0 | h |
| | 1120 | 45 | g | 100 | a | 100 | a | 3 | gh |
| 2,4- D DMA | 280 | 30 | h | 100 | a | 100 | a | 0 | h |
| (Weedar ® 64) | 560 | 38 | gh | 100 | a | 100 | a | 3 | gh |
| | 1120 | 65 | ef | 100 | a | 100 | a | 4 | g |
| 2,4-D 2-ethylhexyl | 280 | 35 | gh | 100 | a | 100 | a | 0 | h |
| ester (Agri Star ®) | 560 | 65 | ef | 100 | a | 100 | a | 0 | h |
| | 1120 | 87 | bc | 100 | a | 100 | a | 9 | f |
| Clopyralid olamine | 280 | 17 | i | 7 | c | 10 | c | 0 | h |
| (Stinger ®) | 560 | 4 | j | 53 | b | 18 | b | 0 | h |
| | 1120 | 5 | j | 59 | b | 23 | b | 0 | h |
| Penoxsulam | 35 | 100 | a | 99 | a | 100 | a | 0 | a |
| (Grasp ® SC) | (g ai/ha) | | | | | | | | |
| Untreated | | 0 | j | 0 | c | 0 | d | 0 | h |

| | | | | |
|---|---|---|---|---|
| LSD (P = 0.05) | 8.7 | 19.7 | 6.4 | 2.4 |
| Standard Deviation | 5.3 | 11.9 | 3.8 | 1.4 |
| CV | 9.86 | 13.69 | 4.58 | 8.69 |

Means followed by same letter do not significantly differ (P = 0.05, Student-Newman-Keuls);
ECHCG = Echinochloa crus-galli (barnyardgrass);
CYDPI = Cyperus difformis (small-flower flatsedge);
MOOVA = Monochoria vaginalis (monochoria);
ORYSP = Oryza sativa (transplanted paddy rice)

TABLE 3
Activity of Herbicidal Compounds in Rice Cropping Systems
(16 Days after Application (DAA)) in the Greenhouse

| | | Percent (%) Visual Injury | | | |
|---|---|---|---|---|---|
| | | Ratings - 16 DAA | | | |
| | Rate | | | | |
| Compound | (g ae/ha) | CYPDI | | MOOVA | |
| Triclopyr triethanolamine | 35 | 100 | a | 84 | a |
| (Garlon ® 3A) | 70 | 98 | a | 89 | a |
| | 140 | 97 | a | 78 | a |
| | 280 | 100 | a | 98 | a |
| Fluroxypyr-meptyl | 35 | 8 | c | 27 | b |
| (Starane ® Ultra) | 70 | 13 | bc | 27 | b |
| | 140 | 20 | bc | 13 | bc |
| | 280 | 33 | b | 5 | c |
| 2,4- D DMA | 35 | 99 | a | 98 | a |
| (Weedar ® 64) | 70 | 100 | a | 90 | a |
| | 140 | 98 | a | 87 | a |
| | 280 | 97 | a | 89 | a |
| Untreated | | 0 | c | 0 | c |

| | | |
|---|---|---|
| LSD (P = 0.05) | 17.6 | 16 |
| Standard Deviation | 10.5 | 9.5 |
| CV | 15.7 | 15.82 |

Means followed by same letter do not significantly differ (P = 0.05, Student-Newman-Keuls);
CYDPI = Cyperus difformis (small-flower flatsedge);
MOOVA = Monochoria vaginalis (monochoria)

TABLE 4
Activity of Herbicidal Compounds in Rice Cropping Systems
(22 Days after Application (DAA)) in the Greenhouse

| | | Percent (%) Visual Injury | | | |
|---|---|---|---|---|---|
| | | Ratings - 22 DAA | | | |
| | Rate | | | | |
| Compound | (g ae/ha) | CYPDI | | MOOVA | |
| Triclopyr triethanolamine | 35 | 100 | a | 92 | a |
| (Garlon ® 3A) | 70 | 100 | a | 89 | a |
| | 140 | 100 | a | 82 | a |
| | 280 | 100 | a | 100 | a |
| Fluroxypyr-meptyl | 35 | 28 | b | 0 | b |
| (Starane ® Ultra) | 70 | 28 | b | 3 | b |
| | 140 | 79 | a | 0 | b |
| | 280 | 89 | a | 15 | b |
| 2,4- D DMA | 35 | 89 | a | 84 | a |
| (Weedar ® 64) | 70 | 76 | a | 72 | a |
| | 140 | 92 | a | 88 | a |
| | 280 | 98 | a | 98 | a |
| Untreated | | 0 | b | 0 | b |

| | | |
|---|---|---|
| LSD (P = 0.05) | 27.9 | 20.4 |
| Standard Deviation | 16.6 | 12.1 |
| CV | 22.05 | 21.85 |

Means followed by same letter do not significantly differ (P = 0.05, Student-Newman-Keuls);
CYDPI = Cyperus difformis (small-flower flatsedge);
MOOVA = Monochoria vaginalis (monochoria)

### Evaluation of In-Water Herbicidal Activity Under Field Conditions

Field trials were conducted in rice using standard herbicide small plot research methodology. Plot size was 2 square meters (m²) using 1.6 meter (m) diameter rings placed into the rice paddy soil with capability for flooding to maintain good rice cultural practices and rice growing conditions. There were 3 replicates per treatment. Rice was Japonica type that was hand-transplanted into the saturated soil in the rings as per normal cultural practices. The transplanted rice crop was grown using normal cultural practices for fertilization, watering, flooding and maintenance to ensure good growth of the crop and the weeds under transplanted rice conditions in Taiwan.

Treatments were applied by mixing the treatments with deionized water just prior to water-injection application by hand to multiple sides in the ring plots. For each 2 m² plot, 50 mL deionized water was mixed with the appropriate formulated product amounts to treat 2 m² to achieve the desired application rates based on unit area of application (hectare). Ring plot water depth was kept at 3 to 7 cm deep before and after water-injection application.

The rice and weeds were evaluated at 28 days after application (DAA). Triclopyr triethylammonium (as Garlon® 3 A, 360 g ae/L); fluroxypyr methylheptyl ester (meptyl or MHE, as Starane® Ultra, 333 g ae/L); 2,4-dichlorophenoxyacetic acid dimethylammonium (2,4-D AMINE, 400 g ae/L SL); penoxsulam (as Grasp® SC, 240 g ai/L); and bensulfuron-methyl (as LONDAX® 10% WAY WP) were used.

The treated and control plots were rated at 28 days after application. Ratings were based on percent (%) visual weed control, where 0 corresponds to no control and 100 corresponds to complete control. Results are reported in Table 5.

TABLE 5
Field Trial Efficacy and Crop Tolerance of Herbicidal Compounds Applied as In-Water Application 10 Days
after Transplanting (DAT) in Transplanted Paddy Rice (evaluated 28 Days After Application (DAA))

| | Rate | Percent (%) Visual Injury Ratings - 28 DAA | | | | | | | | | | | |
|---|---|---|---|---|---|---|---|---|---|---|---|---|---|
| Compound | (g ae/ha) | ORYSP | | ECHCG | | LEFCH | | CYPDI | | SCPJU | | MOOVA | |
| Triclopyr triethanolamine | 140 | 0 | a | 0.0 | a | 0.0 | a | 0.0 | c | 0.0 | c | 0.0 | c |
| (Garlon ® 3A) | 280 | 0 | a | 0.0 | a | 0.0 | a | 0.0 | c | 0.0 | c | 0.0 | c |
| | 560 | 0 | a | 0.0 | a | 0.0 | a | 0.0 | c | 0.0 | c | 0.0 | c |
| Fluroxypyr-meptyl | 140 | 0 | a | 0.0 | a | 0.0 | a | 95.0 | b | 88.3 | b | 0.0 | c |
| (Starane ® Ultra) | 280 | 0 | a | 0.0 | a | 0.0 | a | 98.7 | a | 98.0 | a | 0.0 | c |
| | 560 | 0 | a | 0.0 | a | 0.0 | a | 100.0 | a | 99.3 | a | 60.0 | b |
| 2,4- D | 140 | 0 | a | 0.0 | a | 0.0 | a | 0.0 | c | 10.0 | c | 0.0 | c |
| (2,4-D AMINE) | 280 | 0 | a | 0.0 | a | 0.0 | a | 94.3 | b | 90.0 | b | 6.7 | c |
| | 560 | 0 | a | 0.0 | a | 0.0 | a | 100.0 | a | 100.0 | a | 93.3 | a |
| Untreated | | 0 | a | 0.0 | a | 0.0 | a | 0.0 | c | 0.0 | c | 0.0 | c |

| | | | | | | |
|---|---|---|---|---|---|---|
| LSD (P = 0.05) | 0.0 | 0.0 | 0.0 | 3.65 | 7.05 | 28.64 |
| Standard Deviation | 0.0 | 0.0 | 0.0 | 2.13 | 4.11 | 16.70 |
| CV | 0.0 | 0.0 | 0.0 | 4.36 | 8.46 | 104.36 |

Means followed by same letter do not significantly differ (P = 0.05, Student-Newman-Keuls);
ORYSP = Oryza sativa Japonica (transplanted paddy rice);
ECHCG = Echinochloa crus-galli (barnyardgrass);
LEFCH = Leptochloa chinensis (Chinese sprangletop);
CYDPI = Cyperus difformis (small-flower flatsedge);
SCPJU = Schoenoplectus juncoides (Japanese bulrush);
MOOVA = Monochoria vaginalis (monochoria)

What is claimed is:

1. A method for the selective control of undesirable broadleaf weeds, sedges and barnyardgrass in flooded dry-seeded, water-seeded or transplanted rice comprising applying a herbicidally effective amount of 2,4-D, triclopyr, fluroxypyr, or clopyralid, or an agriculturally acceptable ester or salt thereof, to the flooded rice as an in-water treatment, water injected treatment, or application to a surface of rice paddy water resulting in dispersion of the herbicidally active ingredient throughout the water profile.

2. The method of claim 1, wherein the 2,4-D, triclopyr, fluroxypyr or clopyralid, or an agriculturally acceptable ester or salt thereof is applied at rates of 17 to 1120 grams acid equivalent per hectare (g ae/ha).

3. The method of claim 1, wherein the 2,4-D, triclopyr, fluroxypyr or clopyralid, or an agriculturally acceptable ester or salt thereof are applied at rates of 35 to 560 grams acid equivalent per hectare (g ae/ha).

4. The method of claim 1, wherein the 2,4-D, triclopyr, fluroxypyr or clopyralid, or an agriculturally acceptable ester or salt thereof are applied at rates of 70 to 280 grams acid equivalent per hectare (g ae/ha).

5. The method of claim 1, wherein the undesirable vegetation comprises a herbicide resistant or tolerant weed.

6. The method of claim 5, wherein the herbicide resistant or tolerant weed is a biotype with resistance or tolerance to single or multiple herbicides or single or multiple chemical classes, or inhibitors of single or multiple herbicide modes of action.

7. The method of claim 5 or 6, wherein the resistant or tolerant weed is a biotype resistant or tolerant to acetolactate synthase (ALS) inhibitors, acetohydroxy acid synthase (AHAS) inhibitors, photosystem II inhibitors, acetyl CoA carboxylase (ACCase) inhibitors, photosystem I inhibitors, 5-enolpyruvyl-shikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes of action, arylaminopropionic acids, difenzoquat, endothall or organoarsenicals.

8. The method of claim 1, wherein the rice is 2,4-D-tolerant, glyphosate-tolerant, or glufosinate-tolerant rice.

9. The method of claim 1, further comprising a herbicidally effective amount of an additional herbicide.

10. The method of claim 1, wherein the undesirable vegetation is selected from the group consisting of barnyardgrass (Echinochloa crus-galli), small-flower flatsedge (Cyperus difformis), Japanese bulrush (Schoenoplectus juncoides) and monochoria (Monochoria vaginalis).
